(19) United States
(12) Patent Application Publication
(10) Pub. No.: US 2024/0289243 A1
(43) Pub. Date: Aug. 29, 2024

(54) SERVER AND CONTROL METHOD THEREFOR

(71) Applicant: NANCHANG HUAQIN ELECTRONIC TECHNOLOGY CO., LTD., Jiangxi (CN)

(72) Inventor: YINGCHUN YUAN, Jiangxi (CN)

(21) Appl. No.: 18/574,461

(22) PCT Filed: Nov. 5, 2021
(86) PCT No.: PCT/CN2021/129142

§ 371 Date: Dec. 27, 2023

(30) Foreign Application Priority Data
Jun. 30, 2021 (CN) 202110735814.X

(51) Int. Cl. G06F 11/30; G06F 11/07

(52) U.S. Cl. CPC G06F 11/3024; G06F 11/0766

(57) ABSTRACT

A server in the field of computer networks includes a memory, a CPU connected to the memory, a first power supply connected to and supply power to the CPU, a monitoring module in communication connection with the CPU, and a second power supply connected to and supply power to the monitoring module, where the first power supply and the second power supply are independently arranged. The memory stores an operating system including a main and a backup operating system. The monitoring module records the number of system crashes. If crashes exceed a preset threshold, the CPU restarts, switching between the main and the backup operating systems. With the server and the control method thereof, the operating system running on the CPU, and thus the interrupted service, can be automatically restored, thereby improving server stability and reducing maintenance cost.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/CN2021/129142 filed on Nov. 5, 2021, which claims priority to the benefit of Chinese Patent Application No. 202110735814.X filed in the Chinese Intellectual Property Office on Jun. 30, 2021, the entire contents of which are incorporated herein by reference.

### BACKGROUND

### 1. Technical Field

Embodiments of the present application relate to the field of computer networks, and in particular relate to a server and a control method thereof.

### 2. Background Art

The operating system is a computer program that manages computer hardware and software resources, as well as the kernel and keystone of the computer system. The operating system needs to handle basic services such as managing and configuring the memory, prioritizing system resources, controlling input and output devices, operating networks, managing the file system, and the like.

The traditional computation type server is typically positioned in a machine room, which may increase the risk resistance through mutual backup within a cluster, and will not be greatly affected when a service is interrupted.

The inventor has found at least the following problems in the existing art: for an edge server (a single-node host), cluster backup is impossible since there are no sufficient redundant nodes for backup, and when conditions such as an unexpected power failure, external impact, software crash or the like occur, the operating system may crash and the computation service may be interrupted, resulting in a low operation stability of the edge server; and moreover, since edge servers are widely distributed, the time and labor costs of manual maintenance are relatively high.

### SUMMARY

An object of the embodiments of the present application is to provide a server and a control method thereof, which can automatically recover the operating system running on the central processing unit (CPU), so that an interrupted service can be automatically resumed, thereby improving the stability of the server and reducing the maintenance cost.

In order to solve the above technical problem, an embodiment of the present application provides a server, including: a memory, a CPU connected to the memory, a first power supply connected to and supply power to the CPU, a monitoring module in communication connection with the CPU, and a second power supply connected to and supply power to the monitoring module, where the first power supply and the second power supply are independently arranged: the memory is configured to store an operating system, where the operating system includes a main operating system and a backup operating system: the monitoring module is configured to detect and record a count of crashes of the operating system currently running on the CPU; and the CPU is configured to be restarted when the count of crashes is greater than a preset threshold so that the operating system running on the CPU is switched between the main operating system and the backup operating system.

An embodiment of the present application further provides a method for controlling a server, where the server includes: a memory, a CPU connected to the memory, and a monitoring module in communication connection the CPU, and the method includes:
detecting and recording, by the monitoring module, a count of crashes of the operating system currently running on the CPU; and restarting the CPU when the count of crashes is greater than a preset threshold so that the operating system running on the CPU is switched between the main operating system and the backup operating system.

Compared with the existing art, in the embodiment of the present application, the redundant operating system (the main operating system or the backup operating system) is stored on the memory, the CPU is restarted when the operating system currently running on the CPU has a count of crashes greater than the preset threshold, so that the operating system running on the CPU is switched between the main operating system and the backup operating system, and the operating system running on the CPU is switched to the other operating system as backup. Therefore, the operating system running on the CPU, and thus the interrupted service, can be automatically restored, thereby improving the stability of the server, while the maintenance cost is also reduced since no manual maintenance is desired at the place of the server.

In addition, the monitoring module includes a watchdog counter and a timeout counter: the CPU is configured to send a clear signal to the watchdog counter every other first preset time period: the watchdog counter is configured to continuously increase a count until the clear signal is received or the count exceeds a count threshold, and then clear the count: the timeout counter is configured to add one to a timeout count each time the count of the watchdog counter exceeds the count threshold, and clear the count when the operating system running on the CPU is switched between the main operating system and the backup operating system; and the CPU is configured to be restarted when the timeout count is greater than the preset threshold so that the operating system running on the CPU is switched between the main operating system and the backup operating system.

In addition, the monitoring module further includes a status register having an operating system type parameter stored thereon: the operating system type parameter is configured to switch the operating system running on the CPU to a first operating system; and where the operating system type parameter is used for representing that the operating system currently running on the CPU is one of the main operating system or the backup operating system, and the first operating system is the other of the main operating system and the backup operating system.

In addition, the server further includes a read-only memory configured to store a basic input/output system: where the basic input/output system is configured to be operated when the CPU is restarted, read the count of crashes from the monitoring module, and confirm, according to the count of crashes, to start the main operating system or the backup operating system to run on the CPU.

In addition, the basic input/output system is further configured to be stopped after the operating system running on the CPU is adjusted to the first operating system, until the CPU is restarted next time.

In addition, the sever further includes: a management module connected to the CPU and the monitoring module, respectively: where the management module is configured to receive the clear signal sent from the CPU, and forward the clear signal to the watchdog counter.

In addition, the management module is further configured to record restart information of the CPU, where the restart information is used for representing whether the operating system running on the CPU has been successfully switched; and the management module includes a management network port for other devices to inquire the restart information. In this manner, the restart information of the CPU can be checked and recorded on other devices through the management network port, and thus the operating condition of the CPU can be known, so that intervention measures can be taken in time when the operating condition of the CPU is not good, thereby ensuring stable operation of the server.

In addition, the CPU is further configured to run a default operating system upon startup after a power failure, where the default operating system is the main operating system or the backup operating system.

In addition, a basic input/output system is executed when the CPU is restarted; the basic input/output system reads the count of crashes from the monitoring module, and confirms, according to the count of crashes, to start the main operating system or the backup operating system to run on the CPU, and stops until the CPU is restarted next time; and the CPU reads a configuration file to start running of a service, and feeds a watchdog timer for the monitoring module every other first preset time period to detect the count of crashes.

### BRIEF DESCRIPTION OF THE DRAWINGS

One or more embodiments are illustrated through corresponding figures in the accompanying drawings, but such illustration does not constitute any limitation to the embodiments. Throughout the drawings, elements having like reference numerals represent like elements, and the drawings are not to be construed as limiting in scale unless otherwise specified.

FIG. 1 is a schematic structural diagram of a server according to a first embodiment of the present application;

FIG. 2 is a schematic diagram of a server and a configuration server according to the first embodiment of the present application:

FIG. 3 is a schematic structural diagram of a server (setting management module) according to the first embodiment of the present application:

FIG. 4 is a schematic structural diagram of another server (with no management module) according to the first embodiment of the present application:

FIG. 5 is a flowchart illustrating restarting of a server when the count of crashes is greater than a preset threshold according to the first embodiment of the present application; and

FIG. 6 is a flowchart of a method for controlling a server according to a second embodiment of the present application.

### DETAIL DESCRIPTION OF THE INVENTION

To make the objects, technical solutions and advantages of the embodiments of the present application clearer, embodiments of the present application will be described in detail below with reference to the accompanying drawings. However, it will be appreciated by those of ordinary skill in the art that numerous technical details are set forth in various embodiments of the present application to provide a better understanding of the present application. However, the technical solutions claimed in the present application can be implemented even without these technical details or based on various changes and modifications based on the following embodiments.

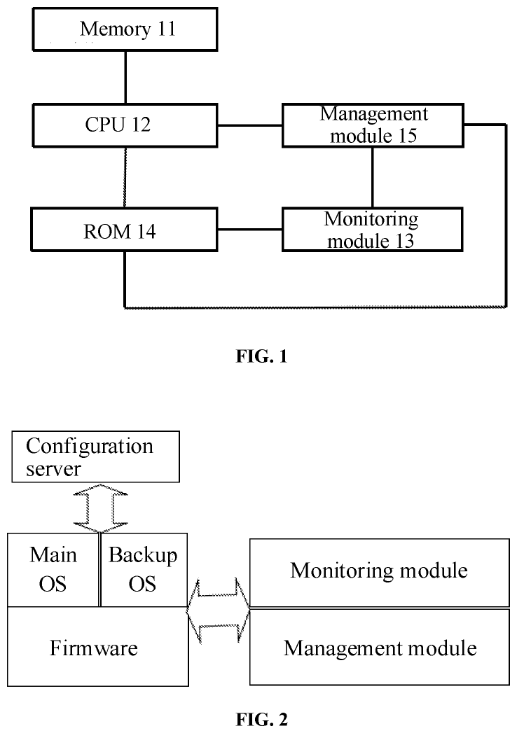

A first embodiment of the present application relates to a server which, as shown in FIG. 1, includes: a memory 11, a CPU 12 connected to the memory 11, a first power supply connected to and supply power to the CPU 12, a monitoring module 13 in communication connection with the CPU 12, and a second power supply connected to and supply power to the monitoring module 13. The first power supply and the second power supply are independently arranged (i.e., the monitoring module 13 and the CPU 12 are independently powered). The memory 11 is configured to store an operating system (OS), where the operating system includes a main operating system and a backup operating system. The monitoring module 13 is configured to detect and record a count of crashes of the operating system currently running on the CPU 12. The CPU 12 is configured to be restarted when the count of crashes is greater than a preset threshold so that the operating system running on the CPU 12 is switched between the main operating system and the backup operating system. The preset threshold may be set as needed, for example, set to 3.

By storing the redundant operating system (the main operating system or the backup operating system) on the memory 11, and starting the CPU 12 when the operating system currently running on the CPU 12 has a count of crashes greater than the preset threshold, so that the operating system running on the CPU 12 is switched between the main operating system and the backup operating system and the operating system running on the CPU 12 is switched to the other operating system as backup, the operating system running on the CPU 12, and thus the interrupted service, can be automatically restored, thereby improving the stability of the server, while the maintenance cost is also reduced since no manual maintenance is desired at the place of the server.

In this embodiment, restarting the CPU 12 may specifically include: controlling power of the first power supply with a CPLD, where the CPLD may be directly connected to a signal related to the first power supply, and control power of the first power supply directly through an operation signal, thereby implementing restart.

In practical applications, the memory 11 is further configured to store firmware. The firmware refers to a “driver” of a device internally stored on the device, through which the operating system can enable operation of a specific machine according to a standard device driver. For example, an optical drive, a recorder, and the like all have internal firmware. As shown in FIG. 2, a configuration file of a service program is placed in a configuration server, and execution units for the service program are configured in two operating systems (a main operating system and a backup operating system) on a local machine.

The monitoring module 13 may be a complex programmable logic device (CPLD) configured to monitor execution states of the service program, the operating system, and the firmware, and may adopt a programming technology such as CMOS EPROM, EEPROM, flash 11, or SRAM, forming a programmable logic device of high density, high speed, and low power consumption.

Specifically, the monitoring module 13 may include a watchdog counter and a timeout counter. The CPU 12 is configured to send a clear signal to the watchdog counter every other first preset time period. The watchdog counter is configured to continuously increase a count until the clear signal is received or the count exceeds a count threshold, and then clear the count. The timeout counter is configured to add one to a timeout count each time the count of the watchdog counter exceeds the count threshold, and clear the count when the operating system running on the CPU 12 is switched between the main operating system and the backup operating system. The CPU 12 is configured to be restarted when the timeout count is greater than a preset threshold, so that the operating system running on the CPU 12 is switched between the main operating system and the backup operating system. In other words, the CPU 12 feeds a watchdog timer (WDT) every other first preset time period, and stops feeding the WDT upon a system crash so that the watchdog counter has a timeout and the monitoring module 13 records one system crash.

Optionally, the monitoring module 13 may further include a status register having an operating system type parameter stored thereon. The operating system type parameter is configured to switch the operating system running on the CPU 12 to a first operating system. The operating system type parameter is used for representing that the operating system currently running on the CPU 12 is one of the main operating system or the backup operating system, and the first operating system is the other of the main operating system and the backup operating system. In other words, the status register records whether the operating system currently running on the CPU12 is the main operating system or the backup operating system, to jointly determine whether to switch according to the count of crashes and which operating system is currently running.

In practical applications, the server may further include a read-only memory 14 (ROM chip) configured to store a basic input/output system. The basic input/output system is configured to be operated when the CPU 12 is restarted, read the count of crashes from the monitoring module 13, and determine whether to start the main operating system or the backup operating system to run on the CPU 12 according to the count of crashes. Specifically, the basic input/output system may be further configured to be stopped after the operating system running on the CPU 12 is adjusted to the first operating system, until the CPU 12 is restarted next time.

The basic input/output system (BIOS) is a standard firmware interface in the industry, which includes a set of programs solidified on a ROM chip of a main board inside the computer, stores the most important basic input/output program, self-checking program after power on, and system self-starting program of the computer, and can read and write specific information of system settings from a CMOS.

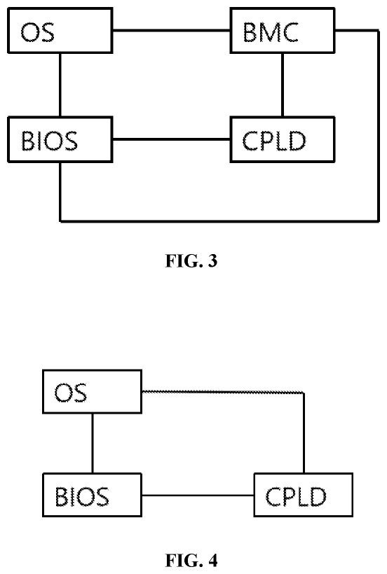

In this embodiment, as shown in FIG. 3, the server may further include: a management module 15 connected to the CPU 12 and the monitoring module 13, respectively. The management module 15 is configured to receive the clear signal sent from the CPU 12, and forward the clear signal to the watchdog counter, and the CPU 12 may acquire the timeout count stored in the timeout counter via the management module 15.

In practical applications, the server may further include: a third power supply connected to and supply power to the management module 15. The third power supply and the first power supply are independently arranged to prevent damage to the first power supply from affecting operation of the management module 15.

Optionally, the management module 15 may be further configured to record restart information of the CPU12. The restart information is used for representing whether the operating system running on the CPU 12 has been successfully switched, including, for example, information like “OS1 (main operating system) failed, switch to OS2 (backup operating system) succeeded” or “switch to OS2 (backup operating system) failed”. The management module 15 includes a management network port for other devices to inquire the restart information. In this manner, the restart information of the CPU 12 can be checked and recorded on other devices through the management network port, remote inquiry of these recorded functions is enabled, and thus the operating condition of the CPU 12 can be known, so that intervention measures can be taken in time when the operating condition of the CPU 12 is not good, thereby ensuring stable operation of the server.

Specifically, the management module 15 may be a baseboard manager controller (BMC), the server further includes a mainboard connected to the CPU 12, and the BMC is in communication with the main board via an IPMI protocol. The BMC may perform operations such as firmware upgrading, machine equipment checking, and the like on the machine without starting the machine. The intelligent platform management interface (IPMI) is an open standard hardware management interface specification that defines a specific communication method for an embedded management subsystem. IPMI information is communicated via the BMC (located on a hardware component of the IPMI specification). Using low-level hardware intelligence management, rather than an operating system for management, has two major advantages: first, this configuration allows out-of-band server management; and second, the operating system is not burdened with the task of transferring system state data.

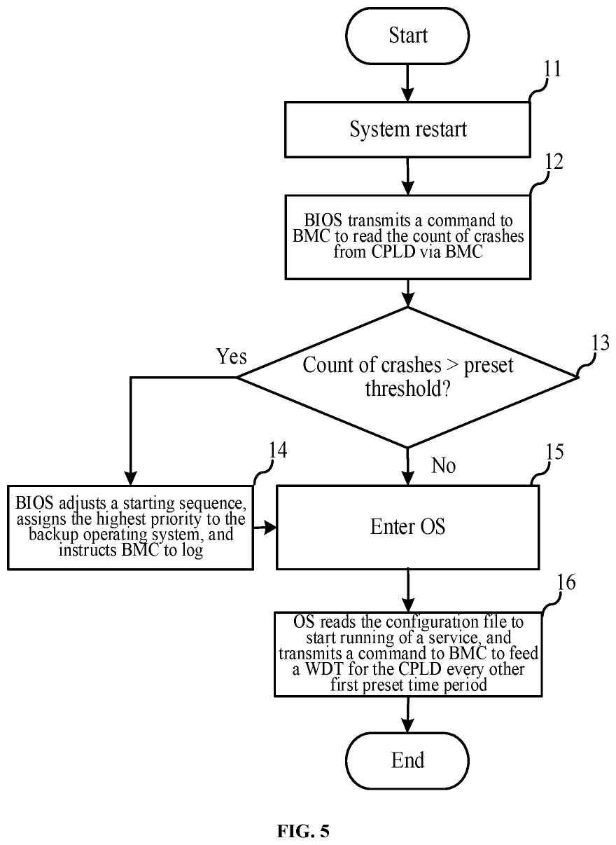

Apparently, as shown in FIG. 4, the management module 15 may be omitted. Instead, the watchdog counter directly receives the clear signal sent from the CPU 12, and then the subsequent CPU12 may directly acquire the timeout count stored in the timeout counter without going through the management module 15.

In practical applications, the CPU 12 may be further configured to run a default operating system upon startup after a power failure. The default operating system is the main operating system or the backup operating system, and in this embodiment, the main operating system is executed upon startup after a power failure. In other words, upon startup after a power failure, the BIOS is executed first to read and write specific information set by the system from the CMOS to implement self-checking after power on, then the right of use is given to the main operating system, while the CPLD is turned on and the BIOS itself is stopped, until the count of crashes is greater than the preset threshold and restart.

FIG. 5 shows a flowchart of restarting when the count of crashes is greater than a preset threshold, which specifically includes the following steps S11 to S16.
At S11: the system is restarted.
At S12: the BIOS transmits a command to the BMC to read the count of crashes from the CPLD via the BMC.
At S13: it is determined whether the count of crashes is greater than a preset threshold; and if the count of crashes is greater than the preset threshold, proceed to step
S14, and if the count of crashes is not greater than the preset threshold, proceed to step S15.
At S14: the BIOS adjusts a starting sequence, assigns the highest priority to the backup operating system, and instructs the BMC to log, and then, proceed to step S15.
At S15: the OS is entered.
At S16: the OS reads the configuration file to start running of a service, and transmits a command to the BMC to feed a watchdog timer for the CPLD every other first preset time period.

Compared with the existing art, in the embodiment of the present application, the redundant operating system (the main operating system or the backup operating system) is stored on the memory 11, the CPU 12 is restarted when the operating system currently running on the CPU 12 has a count of crashes greater than the preset threshold, so that the operating system running on the CPU 12 is switched between the main operating system and the backup operating system, and the operating system running on the CPU 12 is switched to the other operating system as backup. Therefore, the operating system running on the CPU 12, and thus the interrupted service, can be automatically restored, thereby improving the stability of the server and avoiding loss caused by a long time of service interruption, while the maintenance cost is also reduced since no manual maintenance is desired at the place of the server.

A second embodiment of the present application relates to a method for controlling a server, which is applicable to the server of the first embodiment, and the core of the this embodiment lies in including: detecting and recording, by the monitoring module, a count of crashes of the operating system currently running on the CPU; and restarting the CPU when the count of crashes is greater than a preset threshold so that the operating system running on the CPU is switched between the main operating system and the backup operating system. By providing the redundant operating system (the main operating system or the backup operating system), and switching the operating system running on the CPU to the other operating system as backup when the count of crashes is greater than a preset threshold, the operating system running on the CPU 12, and thus the interrupted service, can be automatically restored, thereby improving the stability of the server and avoiding loss caused by a long time of service interruption, while the maintenance cost is also reduced since no manual maintenance is desired at the place of the server.

In practical applications, a basic input/output system is executed when the CPU is restarted: the basic input/output system reads the count of crashes from the monitoring module, and confirms, according to the count of crashes, to start the main operating system or the backup operating system to run on the CPU, and stops until the CPU is restarted next time; and the CPU reads a configuration file to start running of a service, and feeds a watchdog timer for the monitoring module every other first preset time period to detect the count of crashes.

The implementation details of the method for controlling a server according to this embodiment will be described in detail below, and the following description is provided merely for facilitating understanding of the implementation details and is not necessary for implementing the present solution.

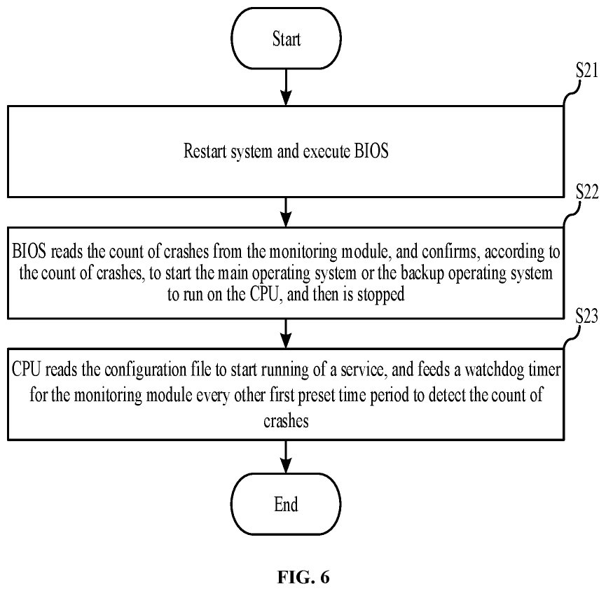

As shown in FIG. 6, the method for controlling a server according to the embodiment specifically includes following steps S21 to S23.
At S21: the system is restarted and the BIOS is executed.
At S22: the BIOS reads the count of crashes from the monitoring module, and confirms, according to the count of crashes, to start the main operating system or the backup operating system to run on the CPU, and then the BIOS is stopped.
At S23: the CPU reads the configuration file to start running of a service, and feeds a watchdog timer for the monitoring module every other first preset time period to detect the count of crashes.

It should be noted that step S22 is a step performed when the server is restarted due to the count of crashes greater than the preset threshold, and upon startup after a power failure, a step of “giving the right of use to the main operating system (i.e., running the main operating system), while turning on the CPLD and stopping the BIOS itself” is performed instead of step S22.

Since the first embodiment corresponds to this embodiment, this embodiment may be implemented in cooperation with the first embodiment. Related technical details mentioned in the first embodiment are still valid in this embodiment, and the technical effects obtained in the first embodiment can also be obtained in this embodiment, which are not described in detail here to reduce repetition. Accordingly, related technical details mentioned in this embodiment are also applicable to the first embodiment.

It will be understood by those of ordinary skill in the art that the foregoing embodiments are specific embodiments of the present application, and that, in practical applications, various changes in form and details may be made therein without departing from the spirit and scope of the present application.

1. A server comprising:
a memory;
a central processing unit (CPU) connected to the memory;
a first power supply connected to and supply power to the CPU;
a monitoring module in communication connection with the CPU; and
a second power supply connected to and supply power to the monitoring module,
wherein the first power supply and the second power supply are independently arranged;
the memory is configured to store an operating system, wherein the operating system includes a main operating system and a backup operating system;
the monitoring module is configured to detect and record a count of crashes of the operating system currently running on the CPU; and
the CPU is configured to be restarted when the count of crashes is greater than a preset threshold so that the operating system running on the CPU is switched between the main operating system and the backup operating system.

2. The server of claim 1, wherein the monitoring module includes a watchdog counter and a timeout counter;
the CPU is configured to send a clear signal to the watchdog counter every other first preset time period;
the watchdog counter is configured to continuously increase a count until the clear signal is received or the count exceeds a count threshold, and then clear the count;
the timeout counter is configured to add one to a timeout count each time the count of the watchdog counter exceeds the count threshold, and clear the count when the operating system running on the CPU is switched between the main operating system and the backup operating system; and
the CPU is configured to be restarted when the timeout count is greater than the preset threshold so that the operating system running on the CPU is switched between the main operating system and the backup operating system.

3. The server of claim 2, wherein the monitoring module further includes a status register having an operating system type parameter stored thereon;
the operating system type parameter is configured to switch the operating system running on the CPU to a first operating system; and
wherein the operating system type parameter is used for representing that the operating system currently running on the CPU is one of the main operating system or the backup operating system, and the first operating system is the other of the main operating system and the backup operating system.

4. The server of claim 1, further comprising a read-only memory configured to store a basic input/output system,
wherein the basic input/output system is configured to be operated when the CPU is restarted, read the count of crashes from the monitoring module, and confirm, according to the count of crashes, to start the main operating system or the backup operating system to run on the CPU.

5. The server of claim 4, wherein the basic input/output system is further configured to be stopped after the operating system running on the CPU is adjusted to the first operating system, until the CPU is restarted next time.

6. The server of claim 2, further comprising: a management module connected to the CPU and the monitoring module, respectively,
wherein the management module is configured to receive the clear signal sent from the CPU, and forward the clear signal to the watchdog counter.

7. The server of claim 6, wherein the management module is further configured to record restart information of the CPU, wherein the restart information is used for representing whether the operating system running on the CPU has been successfully switched; and
the management module includes a management network port for other devices to inquire the restart information.

8. The server of claim 1, wherein the CPU is further configured to run a default operating system upon startup after a power failure, wherein the default operating system is the main operating system or the backup operating system.

9. A method for controlling a server, wherein the server includes a memory, a central processing unit (CPU) connected to the memory, and a monitoring module in communication connection the CPU, the method comprising:
detecting and recording, by the monitoring module, a count of crashes of the operating system currently running on the CPU; and
restarting the CPU when the count of crashes is greater than a preset threshold so that the operating system running on the CPU is switched between the main operating system and the backup operating system.

10. The method for controlling a server of claim 9, further comprising:
running a basic input/output system when the CPU is restarted;
reading, by the basic input/output system, the count of crashes from the monitoring module, and confirming, according to the count of crashes, to start the main operating system or the backup operating system to run on the CPU, and stopping running of the basic input/output system until the CPU is restarted next time; and
reading, by the CPU, a configuration file to start running of a service, and feeding a watchdog timer for the monitoring module every other first preset time period to detect the count of crashes.

11. A non-transitory computer-readable medium storing computer-executable instructions which, when executed by a processor, cause the processor to perform operations for controlling a server including a memory, a central processing unit (CPU) connected to the memory, and a monitoring module in communication connection the CPU, the operations comprising:
detecting and recording, by the monitoring module, a count of crashes of the operating system currently running on the CPU; and
restarting the CPU when the count of crashes is greater than a preset threshold so that the operating system running on the CPU is switched between the main operating system and the backup operating system.

12. The non-transitory computer-readable medium of claim 11, wherein the operations further include:
running a basic input/output system when the CPU is restarted;
reading, by the basic input/output system, the count of crashes from the monitoring module, and confirming, according to the count of crashes, to start the main operating system or the backup operating system to run on the CPU, and stopping running of the basic input/output system until the CPU is restarted next time; and
reading, by the CPU, a configuration file to start running of a service, and feeding a watchdog timer for the monitoring module every other first preset time period to detect the count of crashes.
